(19) United States
(12) Patent Application Publication
(10) Pub. No.: US 2004/0074578 A1
(43) Pub. Date: Apr. 22, 2004

(54) INTERNAL BUTTRESS FOR TIRE BEAD RETENTION

(76) Inventor: Kenneth Dewing, Porterville, CA (US)

Correspondence Address: DONALD D. MON, ATTORNEY AT LAW, SUITE 303, 750 EAST GREEN STREET, PASADENA, CA, 91101, US

(21) Appl. No.: 10/272,477

(22) Filed: Oct. 16, 2002

(51) Int. Cl. B60C 5/16

(52) U.S. Cl. 152/400

(57) ABSTRACT

A buttress to be placed between beads of a pneumatic tire which in turn are clamped against the buttress by adjoining wheel rims. The buttress is a hollow unibody construction formed of plastic material by a rotary molding procedure. The buttress is first formed flat and then bent to a circular shape with the ends pinned together, or as a pair of flat members bent and joined together. It includes a plurality of hollow posts that extend between longitudinal side rail, the side rails being abutted by the rims when installed.

### SPECIFICATION

1. Field of the Invention

Retention to a wheel for tubeless tires that are prone to loss of inflating air pressure, or which are intended to run with very low pressure.

2. Background of the Invention

Vehicular tires are regularly held to their wheel by the reaction between internal pneumatic pressure, the strength of the bead of the tire, and the surrounding wheel and rim construction. The situation is simple and well known for automotive tires which bear light loads and whose failure modes generally involve a gradual loss of pressure and an acceptable mode of release of the tire from the wheel. Examples are tire valve failures, valve stem leakage, minor punctures, and low speed blowouts.

For more stringent applications, self-sealing systems have been proposed. With these systems, sealants inside the tire are relied on to plug leaks when they occur. These are principally intended to extend the time of failure of inflation and to give the operator more time to control his vehicle.

There is a class of vehicle, generally thought of as military or paramilitary in nature, where loss of inflation is not the primary risk. Instead the major risk is loss of the tire itself. It is very desirable and often critical for the vehicle to be able to proceed after an unfortunate event, or to proceed routinely with a tire having very low (or no) pneumatic pressure, a situation which often would be called a flat tire.

An example of an unintended run on a flat tire is where the vehicle is armored, or is a personnel carrier, or any one of many types of vehicles which operate in unfriendly circumstances, and gunfire or spike strips are used against them. Then to be stopped by a flat or lost tire is an intolerable risk to life itself. Another example is when, due to local conditions, it is intentionally run on tires with very low pressure, perhaps only 8 psi. Again successful operation depends on retention of the tire for completion of the task.

It is an object of this invention to provide means to hold the beads of a tire to wheels and rims in such a way that the beads are mechanically gripped and the tire is held to the wheel at the bead whether the tire is inflated or not. The mechanical means is in itself sufficient to hold the beads to the wheel.

It is another object of this invention to provide a buttress with the necessary columnar strength to do its mechanical job, but with minimal weight. This weight is “unsprung”, and in that sense should be minimized. Accordingly, this invention contemplates a hollow buttress structure. In fact, steel buttresses as for the purpose often weigh as much as 34 pounds. A buttress according to this invention can weigh as little as 4 ½ pounds for the same wheel and tire.

It is another object of this invention to provide a manufacturing method that can reliably and economically produce the buttress, which for economy and reliability should be “unibody” and hollow.

### BRIEF DESCRIPTIONS OF THE INVENTION

A buttress according to this invention comprises a rigid body, preferably formed in a circular shape with an exterior envelope so proportioned and arranged as to fit next to an inside central surface of a wheel. The wheel itself includes an integral rim contiguous with the central surface. Wheel bolts and nuts draw a separate rim toward the wheel.

The tire, with the buttress between its beads, is placed between the two rims. The separate rim is then drawn against the tire, which compresses the beads and the buttress into a lateral stack which compressively holds the tire to the wheels by the beads, making an air tight seal while doing so.

The term “bead” as used herein is intended to mean not only the conventional metallic hoop-like internal reinforcement, but also the flexible tire material that surrounds and embeds it.

The buttress itself is manufactured by the rotational molding process in which the outer surfaces of the part are fused to the inside wall of a closed molding cavity. Prior to rotating and heating, plastic material in powder form is weighed and poured into the cavity, and the cavity is heated and rotated. This distributes the powder over the surface of the cavity where it fuses in successive passes over the mold surface, to shape. As a consequence, the part is formed as a hollow body. This enables a strong lightweight structure to be made which is a “unibody” in the sense that it is a single continuous part without joinders such as cemented or welded junctions of two previously made parts that would be needed to hold separatelymade pieces together.

The buttress is preferably formed of a single piece. However, size of the buttress and manufacturing capabilities may require it to be made in two or more segments, which is within the scope of this invention.

The above and other features of this invention will be fully understood from the following detailed description and the accompanying drawings, in which:

### BRIEF DESCRIPTION OF THE DRAWINGS

FIG. 1 is a side view of the presently-preferred embodiment of the invention;

FIG. 2 is a fragmentary side view of FIG. 1, taken at line 2-2 therein;

FIG. 3 is a plan view of the buttress of FIG. 1, laid flat;

FIG. 4 is a cross-section taken at line 4-4 in FIG. 3;

FIG. 5 is a cross-section taken at line 5-5 in FIG. 3;

FIG. 6 is a side view of another embodiment of the invention;

FIG. 7 is a fragmentary side view of FIG. 1, taken at line 7-7 therein;

FIG. 8 is a plan view of one of the segments of the buttress shown in FIG. 6;

FIG. 9 is a plan view of the underside of FIG. 8, two of which constitute the buttress shown in FIG. 6; and

FIG. 10 is an axial cross-section of a wheel incorporating the invention along with a tire mounted to it.

### DETAILED DESCRIPTION OF THE INVENTION

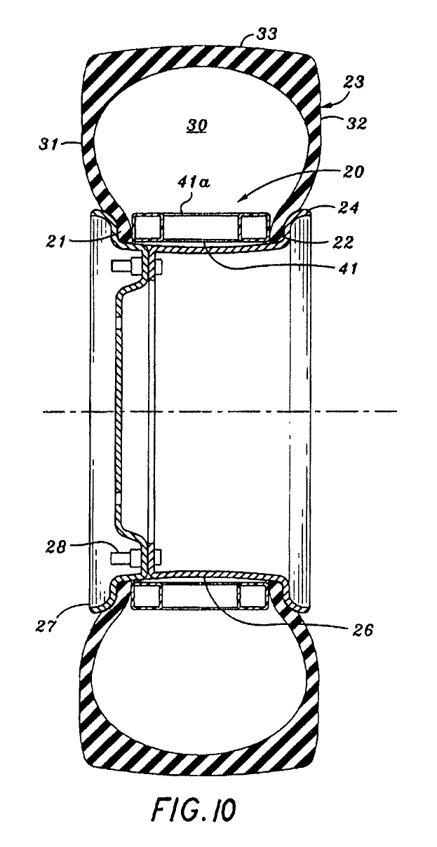

As best shown in FIG. 10, the function of buttress 20 is to provide lateral compressive support against beads 21, 22 of a tire 23. Bead 21 bears against an internal rim 24 of a wheel 25. Rim 24 is integral with the wheel. The wheel has a continuous central surface 26 extending completely around the inside of the wheel. Rim 24 is continuous with, and contiguous to, central surface 26.

A separate rim 27 is held to the wheel by wheel bolts 28 and bears against bead 21 from the outside. Thus tightening the bolts presses the separate rim against bead 21, which in turn presses against the buttress. In turn the buttress presses against bead 22, which then bears strongly against rim 24. There results a solid stack holding the beads to the wheel, which forms a fluid-tight seal on both of the beads that closes the inflation region 30 inside the tire. The sidewalls 31, 32 and tread 33 are shown in the drawing which complete the enclosure.

Although the buttress can be formed from more than one arcuate segment, it is preferable when possible to provide it as a single piece. This preferred construction is shown in FIG. 15. The nature of the rotational molding process is to place the plastic powder inside a flat mold whose inside walls establish the outside surface of the product. In contrast with injection molding techniques, the mold cavity is not completely filled. Instead, by heating and rotating the part properly, the material will fuse and adhere as the powder is being consumed, and be distributed over the entire area of the cavity walls, reducing in volume by 50% as the powder fuses to solid plastic.

The wall thickness of the manufactured part will be determined by the amount of material placed in the mold the more material, the thicken the part. The volume of the mold cavity limits the maximum amount of powder, so the part will always be hollow.

Appropriate organic plastic materials for these segments are, when cured, thermoplastic. They are cured at relatively high temperatures, and when first removed from the mold, and still hot, they are flexible enough to be bent over a mandrel to a proper arcuate shape.

As shown in FIG. 3, the buttress is molded as a flat part. Bending it to shape is done by promptly fixing one end of the buttress, then bending the hot part over a mandrel which is smaller than the desired finish diameter, requiring the loose end to lap past the fixed end in a spiral shape. The loose end is then attached to a hydraulically actuated shoe which then “stretch forms” the buttress as it cools. After cooling, the part will not again encounter sufficient heat for it to become change shape. The mandrel forming operation may cause some wrinkling, but with careful processing, this will not affect the integrity of the part.

Buttress 20 is a single continuous body without seams or joints. As such it is an integral structure a “unibody”. It is completely formed in a single pour, and is not liable to separation. Importantly, it is formed of a single continuous structure. For example, it is not a two piece structure whose parts are joined by welding where they abut. In use, its outside surface 41 faces the wheel, and the inside surface 41a faces into the inflation region 30.

The edge surfaces 42, 43 of both buttress are compressed between the rims. Accordingly it is necessary to provide columnar support (lateral) between them, and also to provide radial support between the inside and outside surfaces to prevent them from bowing outwardly.

For this purpose apertures 44 of suitable number are formed, which because of the way the product is made, results in hollow columns such as column 45, which is typical.

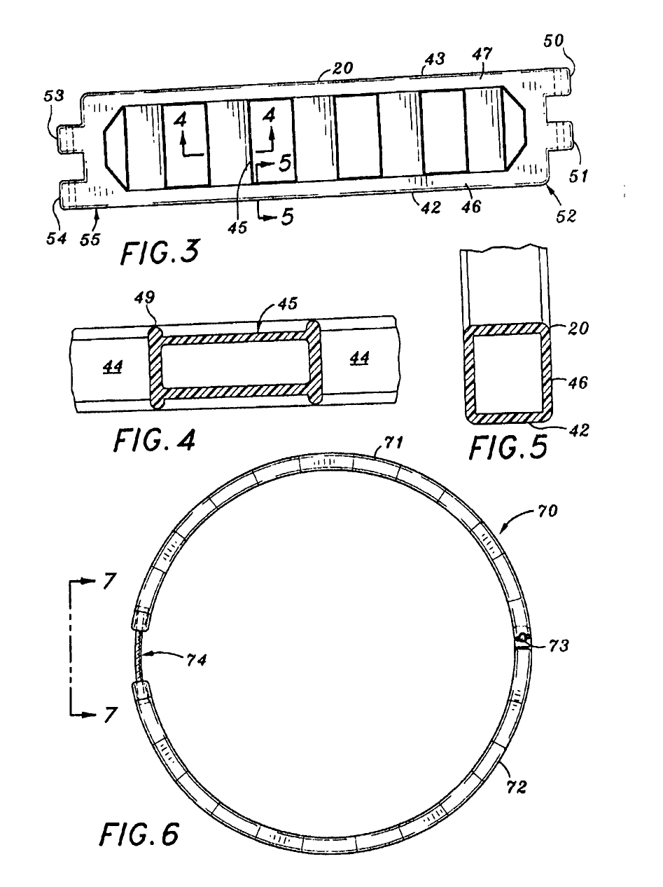

As best shown in FIG. 4 these columns are rectangular in cross-section, although any other hollow prismatic or circularly-sectioned construction could instead be employed. These columns are integrated into the structure of the segment.

These columns, which extend between the inside and outside surface 41 and 41a, and between edge regions 46, 47, provide substantial stiffness to respond to compressive and bending forces from all directions. A peculiarity of the rotational molding process is its capability of thickening the molded structure where two surfaces meet. Accordingly, attention is called to the enlargements 49 characterized by the thickening, which extends around the edge of each opening. This appreciably stiffens the columnar structure. Such enlargement result when the plane 49 of the column is slightly recessed from the surrounding structure as shown.

Posts 50, 51 are formed on one end 52. Posts 53, 54 are formed on the other end 55. It will be observed that posts 50 and 51 are spaced from each other so that, when an identical interleaving segment is brought against it, its posts 50, 51, 53 and 54 will interleave with one another and provide a joinder structure. The joinder is completed by a pin 60 passed through holes in the posts. Pin 60 is preferably plain ended and slightly shorter in length than the distance between surfaces 46 and 47. It is thereby captured while in service.

This product is produced flat, as shown in FIG. 8. Installation of this product is accomplished by threading one end of the open part into the body of the tire 30 until the beadlock is fully within the body of the tire. The tire is then laid flat and the beadlock is pulled out of concentricity with the tire beads 21 and 22, exposing the pin joint. The ends 52 and 55 are then aligned to allow insertion of pin 60. The beadlock is then positioned concentric with the tire and then slid over the wheel surface 26 until the lower tire bend contacts wheel flange 24. The loose rim 27 is then installed to complete the assembly.

Occasionally it will be useful or necessary to provide the buttress in more than one part. While multiple parts can be pinned together using a pin such as pin 60, sometimes a more rigorous construction may be desired.

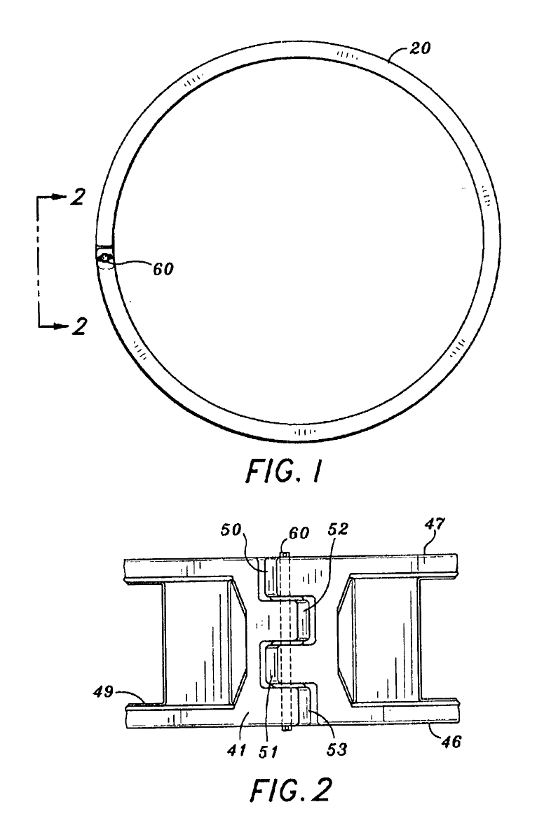

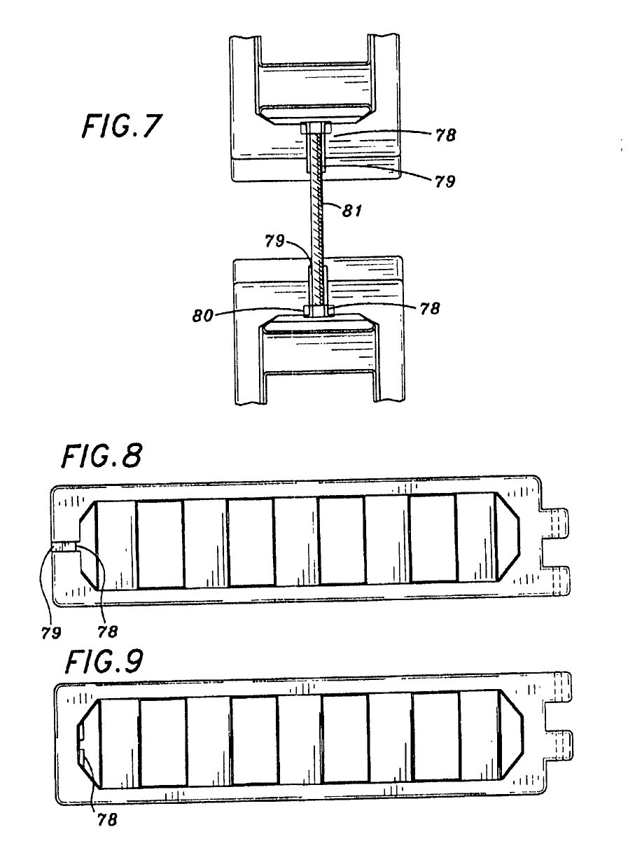

As best shown in FIG. 6, buttress 70 is formed from two segments 71, 72. When complete, the curved segments are joined by a hinge 73, that resembles the connection in FIG. 1. The free ends and the segments are connected by a fastener 74, which will be described later in full detail (FIG. 7). The assembled structure shown in FIG. 6 will be placed inside the wheel, fitting closely to the central surface between the beads, the same as for the device of FIG. 1.

To join the free ends of the segments a fastener 74 can be provided. That enables the segments to be adjusted perfectly to fit the wheel diameter prior to assembly. For this fastener, a cavity 78 is formed with a notch 79 that provides a shoulder for engagement by a nut 80 and passage for a bolt 81 to be engaged by the nut. These are found on the free end of each segment which are identical, but reversed, and the bolt birdies their ends. The effective circumference of the joined segments can be adjusted and held by appropriate tightening of the nut.

The rigid, readily formed and relatively light weight buttress in either embodiment adds mechanical support to the beads of the tire in addition to pneumatic forces which will retain the tire to the wheel even when there is little or no pressure left in the tire.

This invention is not to be limited by the embodiments shown in the drawings and described in the description, which are given by way of example and not of limitation, but only in accordance with the scope of the appended claims.

I claim:

1. In combination:
a pneumatic vehicular tire having a tread, two beads, and two sidewalls extending between the tread and the beads to form an inflation region;
a wheel to which said tire is mounted, said wheel comprising structure forming an internal peripheral central surface, an integral rim adjacent to said central surface at one edge thereof, a separate rim adapted to be held to said structure adjacent to said central surface, and rim retainers holding said separate rim to said structure whereby said tire can surround said central surface with its beads adjacent to respective said rims;
a buttress comprising an initially flat structure having a pair of rigid opposite parallel side faces connected by a pair of parallel edge faces, said structure comprising a pair of parallel edge runners joined by spaced apart hollow columns with apertures between said columns, and posts at each end of said buttress, said posts being so disposed and arranged as to interleave with one another when the buttress is bent into a circular shape;
said buttress being a continuous, molded thermoplastic body;
and a fastener joining said posts;
said buttress being sandwiched between said beads, whereby said rims when said rim retainers are tightened compress the beads and buttress between them to hold them to the wheel.

2. A combination according to claim 1 in which said structure is formed by a rotational molding process.

3. A combination according to claim 2 in which said columns are bounded by a strengthening peripheral reinforcement around each of said apertures.

4. In combination:
a pneumatic vehicular tire having a tread, two beads, and two sidewalls extending between the tread and the beads to form an inflation region;
a wheel to which said tire is mounted, said wheel comprising structure forming an internal peripheral central surface, an integral rim adjacent to said central surface at one edge thereof, a separate rim adapted to be held to said structure adjacent to said central surface, and rim retainers holding said separate rim to said structure whereby said tire can surround said central surface with its beads adjacent to respective said rims;
a buttress comprising a pair of segments each having a pair of rigid opposite parallel side faces connected by a pair of parallel edge faces, each said segment further comprising a pair of parallel edge runners joined by spaced apart hollow columns with apertures between said columns, and posts at one end of each of said buttress, said posts being so disposed and arranged as to interleave with one another when the buttress is formed into a circular shape;
a pin joining said posts;
a fastener joining the other ends of said segments thereby to form a circular buttress; and
said segments each being a continuous body formed of an organic plastic material;
said buttress being sandwiched between said beads, whereby said rims when said rim retainers are tightened compress the beads and buttress between them to hold them to the wheel.

5. A combination according to claim 4 in which each said structure is hollow, having been formed by a rotational molding process.

6. A combination according to claim 5 in which said columns are bounded by a strengthening peripheral reinforcement around each of said apertures.

7. A buttress for fitting between two beads of an inflatable tire, said beads and buttress being compressed in a stack between two rims of wheel, said buttress comprising an initially flat structure having a pair of rigid opposite parallel side faces connected by a pair of parallel edge faces, said structure comprising a pair of parallel edge runners joined by spaced apart hollow columns with apertures between said columns, and posts at each end of said buttress, said posts being so disposed and arranged as to interleave with one another when the buttress is bent into a circular shape;
said buttress being a continuous body formed of an thermoplastic material; and
a fastener joining said posts;
said buttress being sandwiched between said beads, whereby said rims when said rim retainers are tightened compress the beads and buttress between them to hold them to the wheel.

8. A buttress according to claim 7 in which said buttress is a hollow structure formed by a rotational molding process.

9. A buttress according to claim 8 in which said columns are bounded by a strengthening peripheral reinforcement around each of said apertures.

10. A buttress for fitting between two beads of an inflatable tire, said beads and buttress being compressed between two rims of wheel, said buttress comprising:
a pair of initially flat segments each having a pair of rigid opposite parallel side faces connected by a pair of parallel edge faces, each said segment comprising a pair of parallel edge runners joined by spaced apart hollow columns with apertures between said columns, hinged posts at each end of said buttress, and fastener retention means at the other end, said segments being joined into a circular shape by hinges and a fastener.

11. A combination according to claim 10 in which each said structure is hollow, having been formed by a rotational molding process.

12. A combination according to claim 10 in which said columns are bounded by a strengthening peripheral reinforcement around each of said apertures.
